(19) United States
(12) Patent Application Publication
(10) Pub. No.: US 2004/0093717 A1
(43) Pub. Date: May 20, 2004

(54) Method for producing a bar-shaped conductor

(76) Inventors: Thomas Baumann, Wettingen (CH); Thomas Klamt, Schinznach-Dorf (CH); Hans-Christoph Nienburg, Heidelberg (DE)

Correspondence Address: ADAM J. CERMAK, LAW OFFICE OF ADAM J. CERMAK, P.O. BOX 7518, ALEXANDRIA, VA, 22307-7518, US

(21) Appl. No.: 10/472,061

(22) PCT Filed: Mar. 15, 2002
(86) PCT No.: PCT/IB02/00793

(30) Foreign Application Priority Data
Mar. 16, 2001 (DE) 101 13 299.9

(51) Int. Cl. H02K 15/00

(52) U.S. Cl. 29/596

(57) ABSTRACT

The invention relates to a process for manufacturing a conductor bar comprising a number of partial conductors insulated with respect to one another, in particular for a rotating electrical machine, for example a generator, with the following steps:

A: manufacturing partial conductors from an uninsulated conducting endless wire by cutting the endless wire to length, to the length of the partial conductors,

B: deforming the partial conductors by bending,

C: applying an insulation to the bent partial conductors,

D: assembling a number of bent insulated partial conductors to form a conductor bar,

E: bending the assembled conductor bar and/or adhesively bonding the partial conductors of the assembled conductor bar.

### TECHNICAL FIELD

The invention relates to a process for manufacturing an electrically conducting conductor bar comprising a number of partial conductors electrically insulated from one another. Conductor bars of this type may be used for example as stator conductors in rotating electrical machines, for example generators, or in transformers. Conductor bars in which the partial conductors are twisted in a certain manner with respect to one another are also referred to as “Roebel bars”. Unlike steel cables, which are constructed from a multiplicity of steel wires of round cross section or hexagonal cross section, the partial conductors of such a conductor bar regularly have a rectangular cross section.

### PRIOR ART

In order to reduce the electrical losses, for example in a rotating electrical machine, the partial conductors of the stator conductors used therein are insulated from one another and twisted with respect to one another. This requires a three-dimensional bending deformation of each individual partial conductor. A special bending deformation or twisting of individual partial conductors is also referred to as Roebel transposition, with the result that the conductor bar formed from them may also be referred to as a Roebel bar. Such conductor bars or Roebel bars may be formed as stator conductors for a rotating electrical machine, for example for a generator, or for a transformer. The partial conductors of such a conductor bar usually have a rectangular cross section.

A conventional process for manufacturing such conductor bars has the following steps:

1. manufacturing an endless wire with the cross section desired for the partial conductors,

2. applying an electrical insulation to the endless wire,

3. manufacturing the partial conductors from the insulated endless wire by cutting the endless wire to length, to the length of the partial conductors,

4. stripping the ends of the partial conductors, which is required for the forming of electrical terminals on the finished conductor bar,

5. deforming the partial conductors by bending, in particular bending with an offset,

6. assembling a number of-bent partial conductors to form a conductor bar,

7. bending the assembled conductor bar and adhesively bonding the partial conductors of the assembled conductor bar.

In the case of conductor bars which are manufactured in the conventional way, the thickness of the electrical insulations with which the partial conductors of the conductor bar are provided is greatly overdimensioned with respect to their electrically insulating effect. The reason for this is that, in the manufacture of the conductor bar, the insulated partial conductors are subjected to relatively high mechanical loads during their bending deformation, in particular bending with an offset. In order that the insulation of the partial conductors is not destroyed by this, or in order that a sufficient distance can be ensured between the partial conductors if the insulation is damaged, the partial conductors must have a certain minimum thickness or they must additionally be lapped, for example with glass fibers. As a result, the thickness of the partial conductor insulations required for the manufacture of the conductor bars is considerably greater than an insulating thickness which ensures adequate electrical insulation of the partial conductors with respect to one another. In addition, certain bending deformations of the partial conductors which are also referred to as “Roebel transpositions” and are desired for reducing losses may not be realized, since the insulation of the partial conductors is entirely or partially destroyed by this on account of great bending angles, in particular offset bending angles, and/or on account of great width/height ratios of the cross sections of the partial conductors.

### SUMMARY OF THE INVENTION

The present invention is concerned with the problem of providing a manufacturing process for a conductor bar constructed from a number of partial conductors which on the one hand makes it possible to reduce the insulating thickness of the partial conductors and on the other hand ensures the realization of relatively any desired bending deformations of the partial conductors.

This problem is solved according to the invention by a process with the features of claim 1.

The invention is based on the general idea of using for the manufacture of the partial conductors initially an insulated endless wire, deforming the latter in the desired way and only after that applying the insulation to the deformed conductor bar. The procedure according to the invention makes it possible to dimension the insulation of the partial conductors independently of the bending deformation of the partial conductors, with considerably smaller insulating thicknesses being achievable as a result. Since, furthermore, the insulation is only applied after the bending deformation of the partial bars, relatively any desired bending deformations, in particular Roebel transpositions, can be carried out for the partial bars, with extreme bending angles, in particular offset bending angles. In addition, in this case any desired width/height ratios are possible for the cross sections of the partial conductors. This gives rise to new possibilities for configuring the conductor bars, whereby additional increases in performance are possible in the case of the transformers or in the case of the rotating electrical machines in which the conductor bars are used.

A reduction in insulating thickness can be used for example to allow partial conductors with a higher conducting cross section to be used while the overall cross section for the conductor bar remains the same, whereby the electrical loading of the conductor bar can be increased. This can also be used for increasing the performance of the respective machine which contains such conductor bars. Alternatively, the reduction in the insulating thickness of the partial conductors may also be used for a reduction in the overall cross section of the conductor bar, without thereby impairing the performance of the machine equipped with it. It can also be regarded as a further advantage of a reduced partial conductor insulation that the heat transfer between the partial conductors is improved as a result. This is important whenever the partial conductors of the conductor bar heat up differently on account of different losses. The improved heat transfer between the partial conductors allows the different temperatures to be at least partially compensated again.

In the case of a particularly advantageous embodiment, the application of the electrical insulation to the previously bent partial conductors is carried out in such a way that the ends of the partial conductors remain uninsulated. With this procedure, an additional process step, that is the stripping of the ends of the partial conductors, can be omitted in comparison with a conventional production process. The production process can consequently be carried out at lower cost.

The ends of the bent partial conductors may expediently be used when applying the electrical insulation as a point of engagement for a securing means of an insulating apparatus. For example, the partial conductors must be secured by securing means for the application of the insulation in an insulating apparatus, in order for example to carry out a coating operation.

In the case of a development of the process according to invention, the application of the insulation may comprise two substeps, that is a first substep in which the bent partial conductor is coated with a plastics powder and a second substep in which this powder layer is sintered, causing fusing and/or crosslinking of the plastic or forming an insulating layer. This two-part procedure is of advantage, since the application of the powder layer can be carried out in an apparatus optimized for it, for example at ambient temperature, while the sintering of the powder layer for forming the insulating layer is performed in a separate apparatus optimized specifically for it.

For certain insulations it may be advantageous to apply a number of insulating layers. In particular, it is possible to apply a layer of a thermosetting material to an insulating layer in such a way that this layer of thermosetting material is not crosslinked or is crosslinked only partially. This gives rise to the possibility of carrying out the adhesive bonding of the partial conductors of the assembled conductor bar by the crosslinking of the layers of thermosetting material of the partial conductors. Here, too, the manufacture of the conductor bars is simplified, since the application of additional adhesives, such as for example a prepreg nonwoven mat, can be omitted.

Further important features and advantages of the process according to the invention emerge from the subclaims and from the description which follows of preferred exemplary embodiments of the invention.

### WAYS OF IMPLEMENTING THE INVENTION

An uninsulated endless wire which has the cross section of the partial conductors to be manufactured and consists of an electrically conducting material, for example copper, is used for the manufacture of a conductor bar by the process according to the invention. Undeformed partial conductors are then produced from this endless wire by cutting the endless wire to length, to the length of the partial conductors. After cutting to length, the partial conductors are deformed by bending, in particular bent with an offset, in order to achieve the desired three-dimensional form for the partial conductors. In a way corresponding to the basic idea of the present invention, an electrical insulation is only applied after the bending deformation of the partial conductors to the bent partial conductors. After the application of the insulation, a conductor bar can then be assembled from a number of bent and insulated partial conductors. The conductor bar assembled in this way can then once again be subjected to a bending deformation. After that, the adhesive bonding of the partial conductors of the assembled conductor bar is performed, whereby the latter is given its dimensional stability.

The application of the electrical insulation to the partial conductors is preferably performed in such a way that the ends of the partial conductors remain uninsulated. Subsequent stripping of the ends of the partial conductors is consequently omitted. In order to leave the ends of the partial conductors uninsulated when applying the insulation, they may be used for example as engagement points for a securing means of an insulating apparatus. For example, the partial conductors are secured at their ends in an insulating apparatus in such a way that the partial conductors are freely suspended between their ends. Similarly, the partial conductors may be secured at their ends in order to draw them through a coating chamber.

The insulation of the partial conductors may be achieved for example by a powder-coating process. In principle, all filled or unfilled polymers may be used as coating powder, provided that they meet the thermal requirements which occur in the case of the respective conductor bar. Examples of thermally suitable thermoplastics are PEN, PPS, PEEK, PI, PAI and PES. In addition, fluoroplastics are also suitable. Examples of thermally suitable thermosetting materials or elastomers are epoxy and silicone resins and also mixed epoxy/silicone systems. In order to improve the mechanical properties of the insulation, for example in order to reduce the coefficient of thermal expansion or reduce the flowing of the plastic at high temperatures and under high loads, inorganic fillers may be admixed with these plastics, for example in concentrations of 10% to 80%.

The actual coating process is preferably subdivided into two substeps.

In a first substep, a layer of plastics powder is applied, in particular at room temperature, to the already bent partial conductors. This takes place for example in electrostatic fluidized-bed chambers or in electrostatic spray chambers, which may be smaller than the partial conductor to be coated. Such a coating chamber has on opposite sides openings through which the bent partial conductors to be coated are drawn through the chamber individually or more than one at a time. The application rate of the plastics powder, and consequently the achievable layer thickness, are controllable for example by means of the feed with which the partial conductor or the partial conductors are drawn through the chamber and/or the concentration of the atomized powder. In order that the plastics powder remains adhering on the surface of the partial conductors, it is electrostatically charged for the coating operation.

In a second substep, the applied powder layer is sintered in a separate sintering chamber, with the plastics powder melting or fusing. In the case of thermosetting materials, a thermal crosslinking of the plastic then also occurs. The sintering with fusing and/or crosslinking has the effect of forming an insulating layer which forms a closed and homogeneous film. This second substep may also be carried out in a continuous process, it being possible for example for optical or electrical or inductive heating to be provided.

In the case of a preferred embodiment of the process according to the invention, the insulation of the partial conductors may be built up from a number of insulating layers. In the case of a special embodiment, an additional layer of a thermosetting material may be applied to one or more of these insulating layers of thermoplastic or thermosetting material which are already completely sintered or crosslinked. In this case, the sintering process is controlled in such a way that this last layer of thermosetting material is not crosslinked or is crosslinked only partially. The degree of crosslinking may be controlled for example by means of the temperature and by means of the duration of the thermal treatment. The procedure has the effect that this outer layer of thermosetting material is thermally still reactive. If a conductor bar is then assembled from a number of partial conductors which in each case have an outer layer of reactive thermosetting material, the adhesive bonding of the partial conductors of the assembled and possibly bent conductor bar can be carried out particularly simply, in that the layers of thermosetting material then adjacent to one another are crosslinked with one another by corresponding subsequent treatment.

1. A process for manufacturing an electrically conducting conductor bar comprising a number of partial conductors electrically insulated from one another, with the following steps:
A: manufacturing partial conductors from an electrically conducting, not insulated endless wire by cutting the endless wire to the length of the partial conductors,
b: deforming the partial conductors by bending,
c: applying an electrical insulation to the bent partial conductors,
d: assembling a number of bent insulated partial conductors to form a conductor bar,
e: bending the assembled conductor bar and/or adhesively bonding the partial conductors of the assembled conductor bar.

2. The process as claimed in claim 1, characterized in that step C is carried out in such a way that the ends of the partial conductors remain uninsulated.

3. The process as claimed in claim 2, characterized in that the ends of the bent partial conductors are used in step C as engagement points for a securing means of an insulating apparatus.

4. The process as claimed in one of claims 1 to 3, characterized in that step C comprises the following substeps:
C1: powder-coating the bent partial conductor with a plastics powder,
C2: sintering the powder layer with fusing and/or crosslinking of the plastic to form an insulating layer.

5. The process as claimed in one of claims 1 to 4, characterized in that in step C a number of insulating layers are applied.

6. The process as claimed in one of claims 1 to 5, characterized in that in step C a layer of a thermosetting material is applied to an insulating layer in such a way that this layer of thermosetting material is not crosslinked or is crosslinked only partially, the adhesive bonding of the partial conductors of the assembled conductor bar being performed in step E by the crosslinking of these layers of thermosetting material of the partial conductors.

7. The process as claimed in claim 6, characterized in that the thermosetting material is an epoxy resin or a mixed epoxy resin/silicone resin system.

8. The process at least as claimed in claim 4, characterized in that the plastics powder is electrostatically charged for step C1.

9. The process as claimed in one of claims 1 to 8, characterized in that the conductor bar is designed as a Roebel bar.

10. The process as claimed in one of claims 1 to 9, characterized in that the conductor bar is designed as a stator conductor for a rotating electrical machine, in particular a generator, or for a transformer.

11. The process as claimed in one of claims 1 to 10, characterized in that the partial conductors have a rectangular cross section.
